(19) United States
(12) Patent Application Publication
(10) Pub. No.: US 2009/0287816 A1
(43) Pub. Date: Nov. 19, 2009

(54) LINK LAYER THROUGHPUT TESTING

(75) Inventors: Sudheer P.C. Matta, Tracy, CA (US); Matthew S. Gast, San Francisco, CA (US)

Correspondence Address: PERKINS COIE LLP, P.O. BOX 1208, SEATTLE, WA, 98111-1208, US

(73) Assignee: Trapeze Networks, Inc., Pleasanton, CA (US)

(21) Appl. No.: 12/172,195

(22) Filed: Jul. 11, 2008

Related U.S. Application Data
(60) Provisional application No. 61/127,685, filed on May 14, 2008.

(51) Int. Cl. G06F 15/173

(52) U.S. Cl. 709/224

(57) ABSTRACT

A technique for testing a network path involves making use of feedback enabling parameters. Values for the feedback enabling parameters can be generated from a measurement of path performance. The technique can be implemented for wireless paths. The technique can also be implemented for multi-hop paths.

### RELATED APPLICATIONS

This Application claims priority to U.S. Provisional Patent Application No. 61/127,687, filed May 14, 2008, and entitled “LINK LAYER THROUGHPUT TESTING” by Sudheer Matta, which is incorporated herein by reference.

This Application claims priority to U.S. Provisional Patent Application No. 61/127,685, filed May 14, 2008, and entitled “LINK LAYER THROUGHPUT TESTING” by Sudheer Matta, which is incorporated herein by reference.

### BACKGROUND

A network may contain several layers, e.g. physical layer, data link layer, network layer, etc., with each layer potentially being the source of a performance problem. Troubleshooting network performance problems currently entails sending a test from one link layer device to another through all layers of the network. The current troubleshooting methods make it difficult to isolate the problem to a particular network layer.

In a wireless network the wireless link can be the source of poor performance. Wireless networks pose a particular problem because the wireless link may, in fact, be the problem, but current tests do not isolate the link layer, therefore making it difficult to determine whether it is the problem.

Further, the IT administrator does not typically have direct physical access to the device accessing the wireless network, making it difficult to run performance tests. This requires significant time to go to the access location and set up a test under similar user circumstances. The time and cost are compounded when the wireless service provider is located at a remote location to the access point.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system for determining network performance.

FIG. 2 depicts an example of a system performing a link layer performance test.

FIG. 3 depicts a flowchart of an example of a method for testing the performance of a network path.

FIG. 4 depicts an example of a system for monitoring link layer network performance.

FIG. 5 depicts a flowchart of an example of a method for monitoring the performance of a network path.

FIG. 6 depicts a diagram of an example of stations communicating through a wireless mesh network.

FIG. 7 depicts an example of a system performing a mesh path performance test.

FIG. 8 depicts a flowchart of an example of a method for testing the performance of a multi-hop network path.

FIG. 9 depicts an example of a system performing a link layer performance test.

FIG. 10 depicts an example of a system for performing a link layer performance test.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

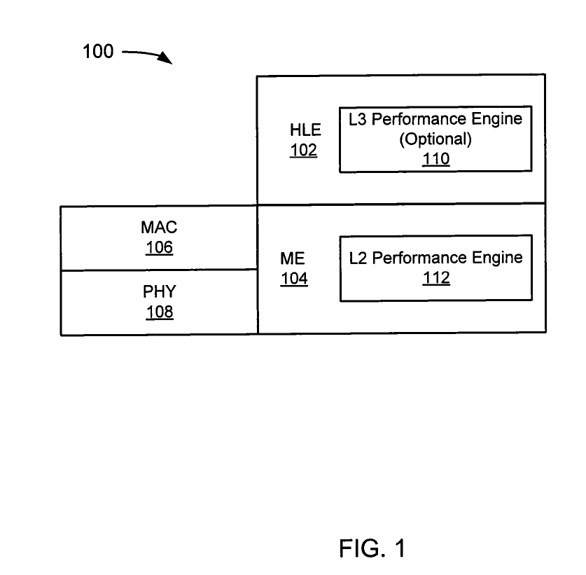

FIG. 1 depicts an example of a system 100 for determining network performance. FIG. 1 includes high level engine (HLE) 102, management entity (ME) 104, media access control layer (MAC) 106, physical layer device (PHY) 108, layer 3 performance engine (L3PE) 110, and layer 2 performance engine (L2PE) 112.

The elements of FIG. 1, as depicted, may be separated and recombined as is known or convenient. It may be possible to include all the elements depicted in a single unit, alternatively, elements depicted may be included on separate units, and the separate units may be connected by one or more networks.

The HLE 102 could be an internetworking gateway, router, mobility manager, controller, engine, or other device benefiting from high level instructions. An engine typically includes a processor and a memory, the memory storing instructions for execution by the processor. The HLE 102 may include one or more functions for interaction with a service access point (SAP). The functions may include messaging capability and decision making capability for high level network operations. In a non-limiting example, the high level network operations may include connect, disconnect, enable new network protocol, test connection, and other high level operations.

The L3PE 110 may optionally be included in the HLE 102, and can be can be implemented, for example, as software embodied in a physical computer-readable medium on a general- or specific-purpose machine, in firmware, in hardware, in a combination thereof, or in any applicable known or convenient device or system. As depicted the L3PE 110 resides in the HLE 102, however, the L3PE 110 may be distributed, or may reside on a separate unit and connected to the system by one or more networks. In a non-limiting example the L3PE can be implemented on a controller in an infrastructure network as software embodied, for example, in a physical computer-readable medium on a general- or specific-purpose machine, firmware, hardware, a combination thereof, or in any applicable known or convenient device or system.

The ME 104 may include sub-layer management entities such as a media access control (MAC) layer management entity (MLME), a physical layer management entity (PLME), and a system management entity (SME). Where the ME 104 includes multiple sub-layer management entities, SAPs may provide points for monitoring and controlling the entities. However, individual units may be divided and combined as is known or convenient and the SAPs may be placed on one or more hardware units as is known or convenient. The ME 104 may be operable to control the activities of a MAC layer as well as one or more PHYs.

The ME 104 includes the L2PE 112. The L2PE 112 can transmit and/or receive data to or from other devices to determine network performance. The L2PE 112 can be can be implemented, for example, as software embodied in a physical computer-readable medium on a general- or specific-purpose machine, in firmware, in hardware, in a combination thereof, or in any applicable known or convenient device or system. As depicted the L2PE 112 resides in the ME 112. Alternatively the L2PE 112 may be distributed, or may reside on a separate unit connected to the system by one or more networks.

The MAC 106 may include SAPs. The SAPs may provide information about messages passed between the MAC 106 and the PHY 108. The PHY 108 may be a radio, although a wired, optical, or other physical layer connection may be used. The example is not limited to a single PHY; a plurality of PHYs may be present.

In the example of FIG. 1, in operation, the system 100 can transmit or receive data as part of a network test. The HLE 102 may receive a trigger to initiate a performance test. Where the HLE 102 is initiating the performance test, the HLE 102 can then trigger the L3PE 110 and/or the L2PE 112 to transmit data as a part of measuring network performance. In performing the test, the ME 104 can instruct the MAC 106 to cause the PHY 108 to transmit one or more test packets. In a non-limiting example, throughput of data transmitted is measured.

Alternatively, where the system 100 is receiving data as a part of a network test, the data can be received at the PHY 108 and the L2PE 112 can measure the performance of a path. The L2PE 112 can then generate and record parameters that enable a network administrator to troubleshoot any performance problems.

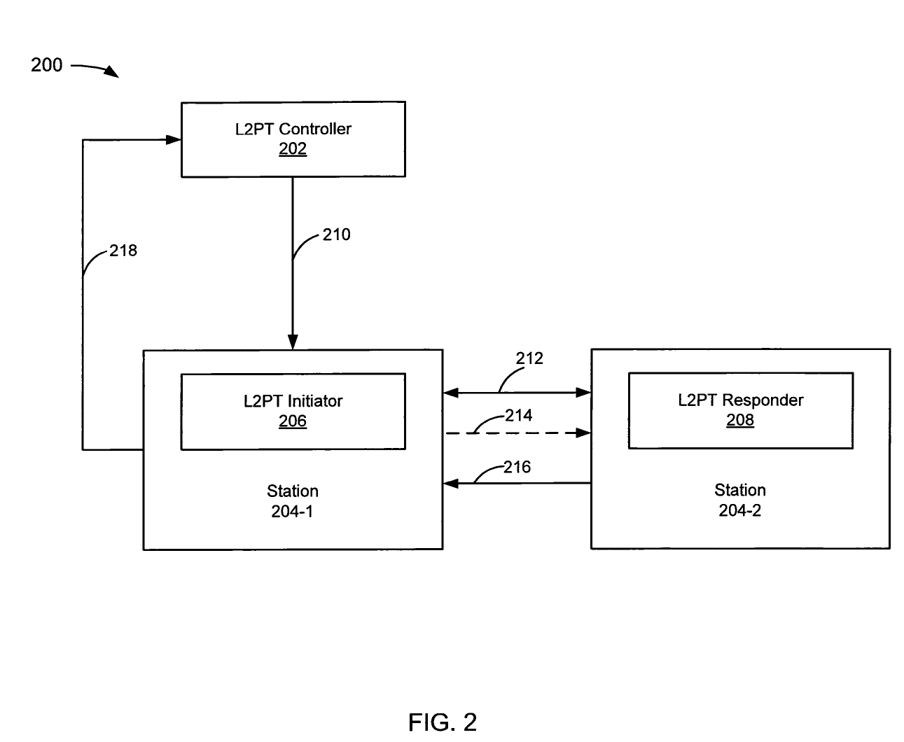

FIG. 2 depicts an example of a system 200 performing a link layer performance test. FIG. 2 includes layer 2 performance test (L2PT) controller 202, station 204-1, station 204-2 (collectively stations 204), L2PT initiator 206, L2PT responder 208. The L2PE from FIG. 1 may be implemented as a L2PT controller, a L2PT initiator, and a L2PT responder distributed as shown in FIG. 2.

In the example of FIG. 2 the L2PT controller 202 can be can be implemented, for example, as software embodied in a physical computer-readable medium on a general- or specific-purpose machine, in firmware, in hardware, in a combination thereof, or in any applicable known or convenient device or system. The L2PT controller 202 may be a separate unit from a station as depicted, or can be included in the same unit as the station. The L2PT controller included in the same unit as the station may include user input/output functionality, e.g. display, buttons, or other known or convenient user interface elements (not shown).

The stations 204 can be wireless access points (APs), mesh points, mesh point portals, mesh APs, mesh stations, client devices, or other known or convenient devices for network performance analysis. Station 204-1, as depicted, includes the L2PT initiator 206 which can be can be implemented, for example, as software embodied in a physical computer-readable medium on a general- or specific-purpose machine, in firmware, in hardware, in a combination thereof, or in any applicable known or convenient device or system. The L2PT initiator 206 can be a separate unit, or can be integrated with the station 204-1. Station 204-2, as depicted, includes the L2PT responder 208 which can be can be implemented, for example, as software embodied in a physical computer-readable medium on a general- or specific-purpose machine, in firmware, in hardware, in a combination thereof, or in any applicable known or convenient device or system. Additionally, the L2PT responder 208 may be a separate unit as well.

Notably, a L2PT initiator and a L2PT responder may be a single unit and may have dual functionality, where convenient. Further, the L2PT controller may be included in a single unit with the L2PT initiator and the L2PT responder.

In the example of FIG. 2, in operation, the L2PT controller 202 triggers, as indicated by indicator 210, a performance test of the path between the stations 204. The L2PT controller 202 may identify a set of feedback enabling parameters, for which values are to generated, based on the performance of the test. Feedback enabling parameters can be, but are not limited to, prioritization, aggregation, security, data rate, and any known or convenient feedback enabling parameter. The L2PT controller 202 may trigger the test automatically or it may trigger the test in response to a command from a systems administrator. In a non-limiting example the test could be triggered by pressing a button provided on a station where the controller resides (not shown).

The L2PT initiator 206 receives the trigger and initializes a test with the L2PT responder 208, as indicated by indicator 212. Initialization may include determining the number of packets and packet characteristics. After the test is initialized, station 204-1 sends a test packet to station 204-2, as indicated by indicator 214. The L2PT responder 208 can generate values for the feedback enabling parameters, record them, or report them to the L2PT initiator 206, as indicated by indicator 216. Alternatively, a bi-directional test may be run with station 204-2 also sending a test packet to station 204-1 and the L2PT initiator 206 generating values for the feedback enabling parameters. The feedback enabling parameter values can be reported to the L2PT controller 202 as indicated by indicator 218.

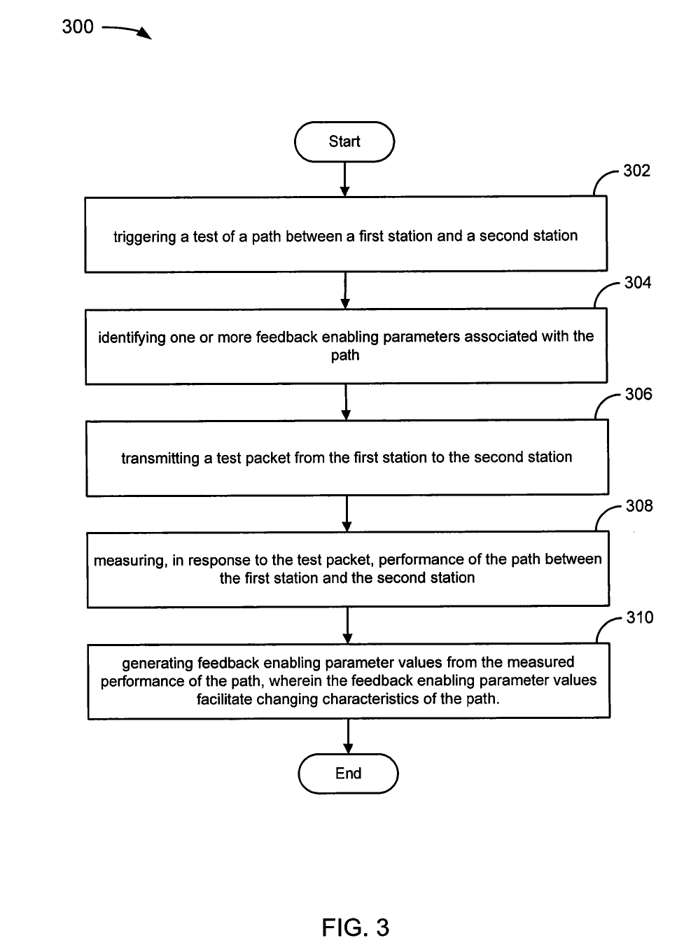

FIG. 3 depicts a flowchart 300 of an example of a method for testing the performance of a network path. The method is organized as a sequence of modules in the flowchart 300. However, it should be understood that these, and modules associated with other methods described herein, may be reordered for parallel execution or into different sequences of modules.

In the example of FIG. 3, the flowchart 300 starts at module 302 with triggering a test of a path between a first station and a second station. The test can be triggered in any applicable convenient manner. For example, the test can be triggered automatically in response to observed poor network performance. As another example, the test can be triggered by a network administrator in response to a user complaint of poor network performance. As another example, the test can be triggered by software on behalf of a user in response to indications of poor network performance.

In the example of FIG. 3, the flowchart 300 continues to module 304 with identifying one or more feedback enabling parameters associated with the path. The feedback enabling parameters may be, but are not limited to, prioritization, aggregation, security, and data rate. The above listed parameters are of particular interest because they are specific to the data link network layer. Layer link network parameters are useful because link network layer parameters typically cannot be learned at Layer 3.

In the example of FIG. 3, the flowchart 300 continues to module 306 with transmitting a test packet from the first station to the second station. Such a test could be a bi-directional test with the second station also transmitting a test packet to the first station.

In the example of FIG. 3, the flowchart 300 continues to module 308 with measuring in response to the test packet, performance of the path between the first station and the second station. The L2PT responder may identify the number of frames received, the total time necessary for transmission, and other information relevant to evaluating performance.

In the example of FIG. 3, the flowchart 300 continues to module 310 with generating one or more feedback enabling parameter values from the measured performance of the path, wherein the feedback enabling parameter values facilitate changing characteristics of the path. The feedback enabling parameters may then be transmitted to a systems administrator who can determine whether the network link layer has a performance problem or to look to other network layers as the source of the problem. The systems administrator may then perform an action to improve, or decrease, performance of the path. Alternatively, network configuration may be performed automatically by, for example, a software program.

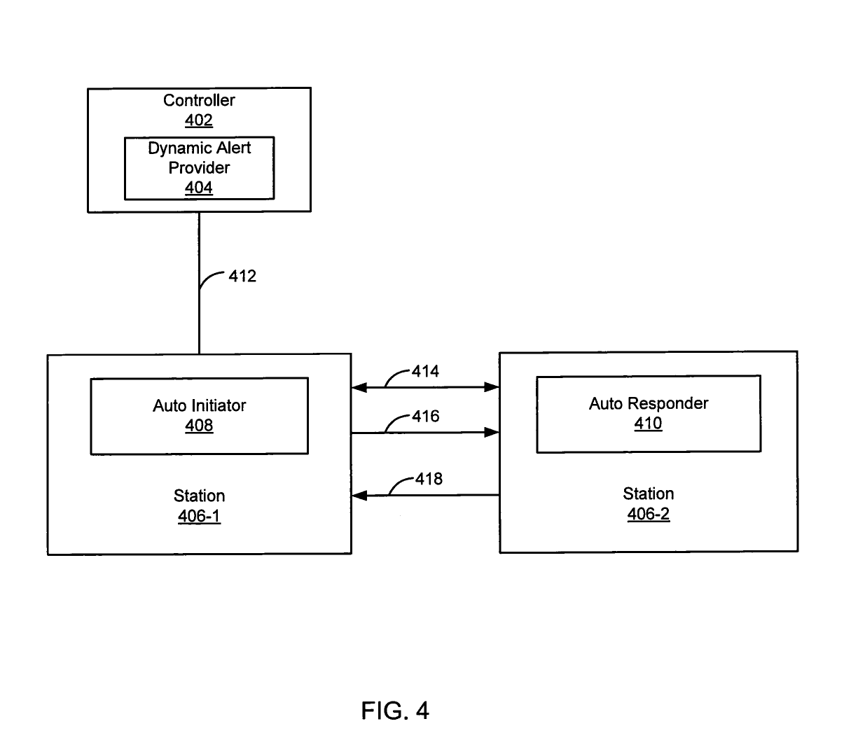

FIG. 4 depicts an example of a system 400 for monitoring link layer network performance. FIG. 4 includes controller 402, dynamic alert provider 404, station 406-1, station 406-2 (collectively stations 406), auto initiator 408, auto responder 410.

In the example of FIG. 4 the controller 402 can be can be implemented, for example, as software embodied in a physical computer-readable medium on a general- or specific-purpose machine, in firmware, in hardware, in a combination thereof, or in any applicable known or convenient device or system. The controller 402 may be a separate unit from a station as depicted; the units depicted may be combined or divided and connected by networks as is known or convenient.

In the example of FIG. 4 the dynamic alert provider 404 can include known or convenient input and/or output devices. For example, the dynamic alert provider 404 can include a known or convenient display device. The display device may or may not include input functionality, such as a button or a touch screen display. As another example, the dynamic alert provider 404 can include a known or convenient audio alert device. The exact characteristics of the dynamic alert provider 404 are not critical, and any known or convenient alert mechanism could be employed.

The stations 406 can be wireless access points (APs), mesh points, mesh point portals, mesh APs, mesh stations, client devices or any known or convenient network devices. Station 406-1, as depicted includes the auto initiator 408 which can be can be implemented, for example, as software embodied in a physical computer-readable medium on a general- or specific-purpose machine, in firmware, in hardware, in a combination thereof, or in any applicable known or convenient device or system. The auto initiator 408 can be a separate unit and located as is convenient. The auto responder 410 as depicted is included on station 406-2 and can be can be implemented, for example, as software embodied in a physical computer-readable medium on a general- or specific-purpose machine, in firmware, in hardware, in a combination thereof, or in any applicable known or convenient device or system. Alternatively, the auto responder 410 may be a separate unit and can be located as is known or convenient. An auto initiator 408 and an auto receiver 410 may be combined in a single unit with dual functionality. Further, a controller may also include an auto initiator and an auto receiver and may be located as is known or convenient.

In the example of FIG. 4, in operation, the auto initiator 408 initializes a test of a path between the stations 406 with the auto responder 410 as indicated by indicator 414. This test can be triggered based on a predetermined condition such as a user complaint. Or the test can be triggered automatically after a predetermined monitoring period. Or the test can be triggered in response to a signal or other trigger received from the controller 402 as indicated by indicator 412. Initializing the test may include identifying one or more feedback enabling parameters and notifying the auto responder 410 to return or record values for the feedback enabling parameters.

Station 406-1 sends a test packet to station 406-2 as indicated by indicator 416. The auto responder 410 can measure the performance of the path between the stations 406 and can generate values for the feedback enabling parameters. The test of the path between the stations 406 may be bi-directional with station 406-2 also sending a test packet to station 406-1. The auto initiator 408 can measure the performance of the reverse path between the stations 406 and can generate values for the feedback enabling parameters.

The feedback enabling parameter values may be recorded or sent to the controller 402 as indicated by indicator 412. The values may additionally be displayed or otherwise communicated to a systems administrator by the dynamic alert provider 404. The systems administrator may then perform actions to improve, or decrease, the network performance, or may request additional tests be performed.

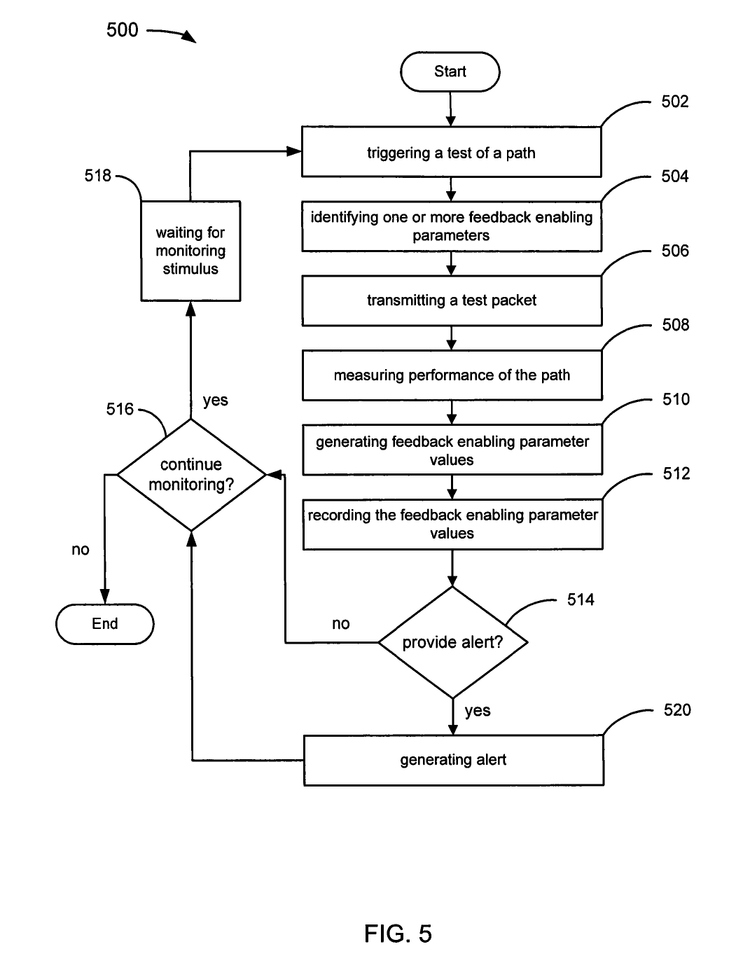

FIG. 5 depicts a flowchart 500 of an example of a method for monitoring the performance of a network path. The method is organized as a sequence of modules in the flowchart 500. However, it should be understood that these, and modules associated with other methods described herein, may be reordered for parallel execution or into different sequences of modules.

In the example of FIG. 5, the flowchart 500 starts at module 502 triggering a test of a path. This test can be triggered automatically in response to, for example, a user complaint through an automated system, a request by a systems administrator, or the passing of a predetermined monitoring period. These examples are not intended to be exhaustive. For example, the test can also be triggered by activating a switch, pressing a button provided on a station, or in some other manner.

In the example of FIG. 5, the flowchart 500 continues to module 504 with identifying one or more feedback enabling parameters. The feedback enabling parameters can include prioritization, aggregation, security, and data rate, or another applicable known or convenient parameter. The above listed parameters are of particular interest because they are specific to the data link network layer. Layer link network parameters are useful because link network layer parameters typically cannot be learned at Layer 3.

In the example of FIG. 5, the flowchart 500 continues to module 506 with transmitting a test packet. Depending upon the embodiment, implementation, and/or configuration, the test can be bi-directional with test packets being sent and received by a first and a second station (not shown).

In the example of FIG. 5, the flowchart 500 continues to module 508 with measuring the performance of the path. The auto responder may identify the number of frames received, the total time necessary for transmission, and/or other information relevant to evaluating performance. In a bi-directional test the auto initiator may also identify the number of frames received, the total time necessary for transmission, and/or other information relevant to evaluating performance.

In the example of FIG. 5, the flowchart 500 continues to module 510 with generating feedback enabling parameter values. Values for the identified feedback enabling parameters can be generated for the path in one direction, the path in both directions collectively, or in each direction separately.

In the example of FIG. 5, the flowchart 500 continues to module 512 with recording the feedback enabling parameter values. The feedback enabling parameter values can be recorded in local memory on the responder, the initiator, or the station. The values can be recorded remotely on, for example, a known or convenient storage device coupled to the network.

In the example of FIG. 5, the flowchart 500 continues to decision point 514 with determining whether an alert is to be provided. In a non-limiting example, an alert may be provided based on predetermined threshold values for the feedback enabling parameters. For example, an alert may be provided every time a test is run.

In the example of FIG. 5 the flowchart continues to decision point 516, where it is determined whether to continue monitoring. If it is determined not to continue monitoring (516-no), the flowchart 500 ends. If, on the other hand, it is determined to continue monitoring (516-yes), the flowchart 500 continues to module 518 with waiting for a monitoring stimulus before continuing to module 502, which was described previously. Waiting for a monitoring stimulus may include, for example, waiting for a specific request to run a test from a systems administrator or from software triggered by a user query about network performance. Thus, the monitoring stimulus could be from a dynamic event. As another example, waiting for a monitoring stimulus may include waiting for a periodic stimulus as part of an ongoing monitoring process. Thus, the monitoring stimulus could be time-dependant. If multiple paths are tested, the testing could be conducted simultaneously across multiple paths or alternatively across multiple paths.

In the example of FIG. 5, if it is determined that an alert is to be provided (514-yes), the flowchart 500 continues to module 520 with generating the alert. The alert may be provided to a systems administrator through, for example, a graphical display, an auditory signal, or some other known or convenient alert mechanism. The flowchart 500 then continues to decision point 516, which was described previously.

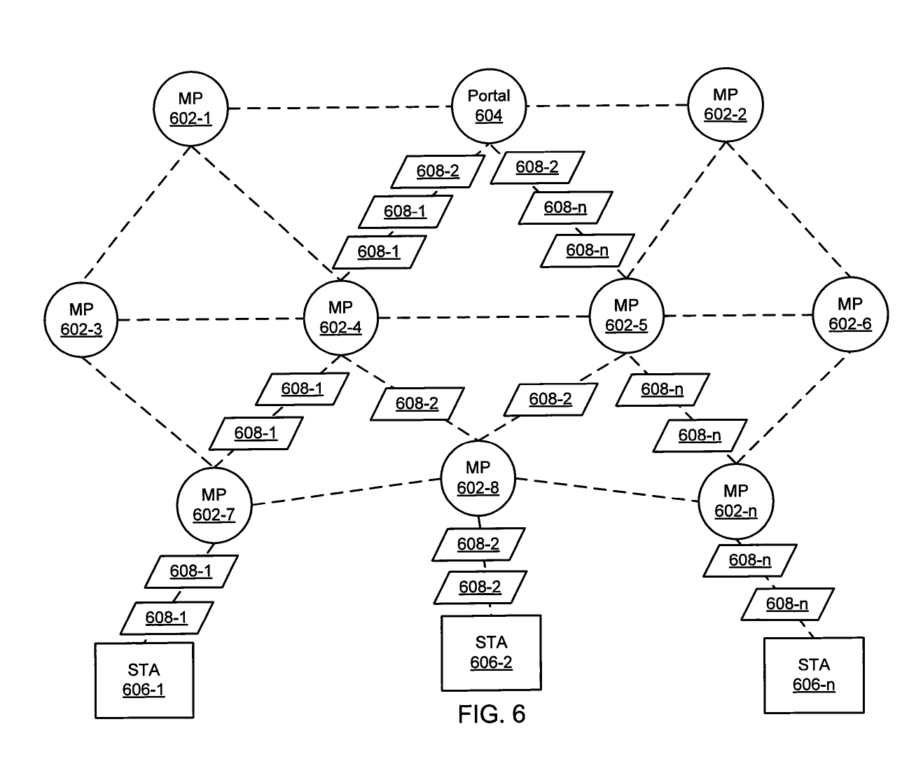

FIG. 6 depicts a diagram 600 of an example of stations communicating through a wireless mesh network. FIG. 6 includes mesh point (MP) 602-1, MP 602-2, MP 602-3, MP 602-4, MP 602-5, MP 602-6, MP 602-7, MP 602-8, MP 602-n (collectively MPs 602), portal 604, station (STA) 606-1, station 606-2, station 606-n (collectively STAs 606), and a plurality of packets 608.

In the example of FIG. 6 each of the MPs 602 may be any device that uses its network interface to relay traffic from other mesh points or stations. A mesh point may, along with relaying traffic, use its network interface to access the network itself. The MPs 602 may also act as mesh APs, mesh point portals, or APs. The MPs 602 may be connected in a full mesh topology, each MP connecting to all other MPs within the network, providing redundancy if one or more MPs fail. Alternatively, the MPs 602 may be connected in a partial mesh topology, some MPs connected to all others and some only to the peer MPs through which they exchange the most data.

In the example of FIG. 6 the wireless mesh network is depicted having MPs connecting to all other MPs within range. For example, MP 602-7 is depicted as connected to MP 602-3, MP 602-4, and MP 602-8. The example is by way of example not limitation and the mesh network may be connected in other topologies which are known or convenient.

In the example of FIG. 6 the portal 604 may be any device that is connected to an outside network and forwards traffic in and out of the mesh. An example of an outside network may be any type of communication network, such as, but not limited to, the Internet or an infrastructure network. The term “Internet” as used herein refers to a network of networks which uses certain protocols, such as TCP/IP, and possibly other protocols, such as the hypertext transfer protocol (HTTP), for hypertext markup language (HTML) documents that make up the World Wide Web (the web). The portal 604 may also act as a mesh point or a mesh AP.

In the example of FIG. 6 the stations 606 may be any computing device capable of WLAN communication, for example a notebook computer, a wireless phone, or a personal digital assistant (PDA). The stations 606 may be, but are not limited to, APs, mesh points, mesh stations, mesh APs, or client stations.

In the example of FIG. 6 the plurality of packets 608 may include packets prioritized as voice, video, best effort and background. A packet may be any formatted block of data to be sent over a computer network. A typical packet can consist of control information and user data. The control information can provide the data needed to deliver the user data, for example, source and destination addresses. The user data is the data being sent over the network and may include voice, video, audio, text, or any other type of data.

In the example of FIG. 6, in operation, packets may be transmitted through the mesh between an outside network, through portal 604, and the stations 606. Alternatively a station may communicate directly with another station through the mesh network. For example, station 606-1 may communicate with station 606-2 through the mesh including MP 602-7 and 602-8.

The plurality of packets 608 are shown traveling to and from the stations 606 through the portal 604. As depicted, congestion arises as the frames funnel toward the portal 604. Higher priority frames may receive special treatment and may be moved to the front of the queue for passage through the mesh points 602 or the portal 604. For example, station 606-2 may be a wireless device, such as a voice over internet protocol (VoIP) device, using the network to transmit data characterized as high priority voice. In the example of FIG. 6, the voice packets are given preference as they proceed through the mesh and the portal 604. As high priority frames are given precedence above lower priority frames, the lower priority frames may be delayed in transmission. The natural bottleneck effect of traffic flowing through the portal is compounded for lower priority traffic by high priority traffic being given preference.

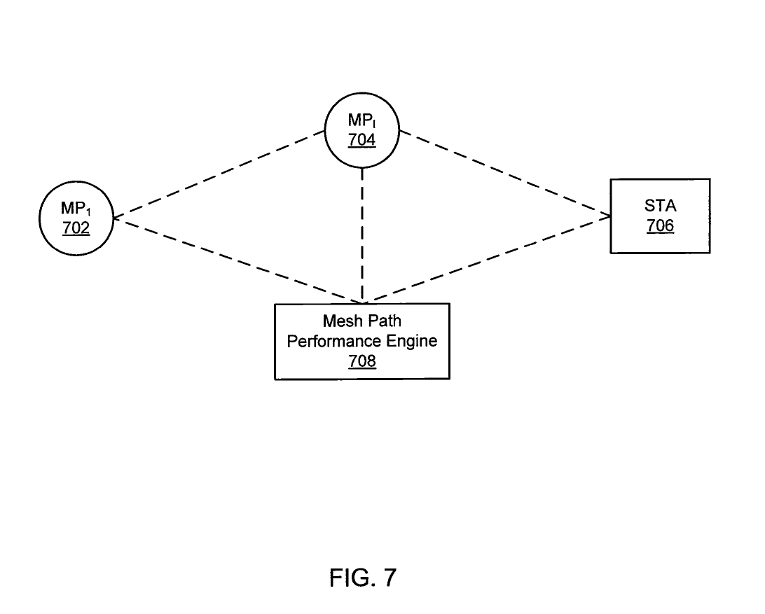

FIG. 7 depicts an example of a system 700 performing a mesh path performance test. FIG. 7 includes MP₁ 702, intermediary mesh point (MP₁) 704, station 706, and mesh path performance engine (MPPE) 708.

In the example of FIG. 7 MP₁ 702 may be an AP, a mesh point, a mesh point portal, or a mesh point AP. A mesh point can be any device that uses its network interface to relay traffic from other mesh points or stations. A mesh point may, along with relaying traffic, use to access a network via the mesh point's own network interface. A mesh point portal can be any device that is connected to an outside network and forwards traffic in and out of the mesh. MP₁ 704 may be one of the one or more intermediary mesh points defining a path between MP₁ 702 and station 706. MP₁ 704 may be an AP, a mesh point, or a mesh AP. As depicted in FIG. 7 there is a single intermediary mesh point, MP₁ 704, however, a plurality of intermediary mesh points may be used. Station 706 may be a mesh point, a mesh station, a mesh AP or a client station.

In the example of FIG. 7 MPPE 708 can be can be implemented, for example, as software embodied in a physical computer-readable medium on a general- or specific-purpose machine, in firmware, in hardware, in a combination thereof, or in any applicable known or convenient device or system. As depicted MPPE 708 may be implemented as a separate unit and connected to the mesh through a network. The MPPE 708 can be included on one or more of the mesh points, or stations, in the mesh. Alternatively, the MPPE 708 may be implemented as separate pieces of logic distributed as would be convenient.

In the example of FIG. 7, in operation, the MPPE 708 receives a command to trigger a test of a multi-hop path between MP₁ 702 and station 706. This command may be triggered automatically by an HLE in response to a predetermined event, for example but not limited to, a user complaint, or a set time period. Alternatively the command may be triggered by a systems administrator. The MPPE 708 can identify feedback enabling parameters, for example, prioritization, aggregation, security, and data rate, which are associated with the multi-hop path.

MPPE 708 may instruct station 706 to send a test packet to MP₁ 702 through the multi-hop path, which includes MP₁ 704. The MPPE 708 can also instruct MP₁ to send a test packet to station 706 through the multi-hop path in order to perform a bi-directional test. The MPPE 708 measures performance of the multi-hop path with respect to the test packet and calculates values for the feedback enabling parameters. These values may be recorded or sent to a systems administrator.

Further tests can be triggered. For example, if the feedback enabling parameter values are unacceptable the systems administrator may trigger a test between station 706 and MP₁ 704 to isolate the performance problem to a specific hop in the multi-hop path or between hops of MP₁ 704, if it includes multiple hops. Similarly, a test may be triggered between MP₁ 704 and MP₁ 702. In a path with more hops than that depicted, a single hop may be eliminated with each test until the performance problem has been isolated. Alternatively, a test for each hop of the multi-hop path may be run automatically along with the multi-hop test.

Alternatively, a second test may be triggered to use a multi-hop path that is distinct from the previous path tested. The results of the two tests can be compared and traffic may be routed based on the comparison. Traffic may be routed in order to speed up communication between MP₁ 702 and station 706. Alternatively, traffic may be routed in order to slow down communication between MP₁ 702 and station 706.

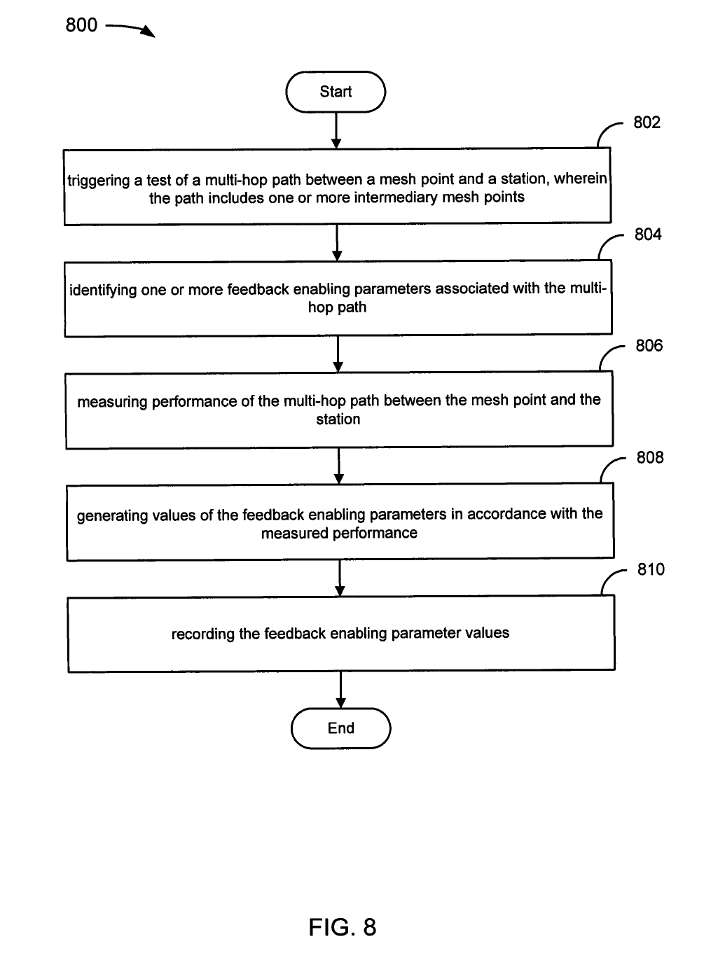

FIG. 8 depicts a flowchart 800 of an example of a method for testing the performance of a multi-hop network path. The method is organized as a sequence of modules in the flowchart 800. However, it should be understood that these, and modules associated with other methods described herein, may be reordered for parallel execution or into different sequences of modules.

In the example of FIG. 8, the flowchart 800 starts at module 802 triggering a test of a multi-hop path between a mesh point and a station, wherein the path includes one or more intermediary mesh points. This test may be triggered automatically in response to, by way of example and not limitation, a user complaint through an automated system, a request by a systems administrator, or the passing of a predetermined monitoring period. Additionally the test may be triggered by activating a switch or pressing a button provided on a mesh point or a station.

In the example of FIG. 8, the flowchart 800 continues to module 804 with identifying one or more feedback enabling parameters associated with the multi-hop path. The feedback enabling parameters may be, but are not limited to, prioritization, aggregation, security, and data rate. The above listed parameters are of particular interest because they are specific to the data link network layer.

In the example of FIG. 8, the flowchart 800 continues to module 806 with measuring performance of the path between the mesh point and the station. The measurement may be to identify the number of frames received by the station, the total time necessary for transmission, and other information relevant to evaluating performance. In a bi-directional test the measurement may also identify the number of frames received by the mesh point, the total time necessary for transmission, and other information relevant to evaluating performance.

In the example of FIG. 8, the flowchart 800 continues to module 808 with generating values of the feedback enabling parameters in accordance with the measured performance. Values for the identified feedback enabling parameters may be generated for the path in one direction, the path in both directions collectively, or in each direction separately.

In the example of FIG. 8, the flowchart 800 continues to module 810 with recording the feedback enabling parameter values. The feedback enabling parameter values may be recorded in local memory on the responder, the initiator, or the station. The values may be recorded remotely on, for example, a network attached storage device or a hard drive in a general purpose computer.

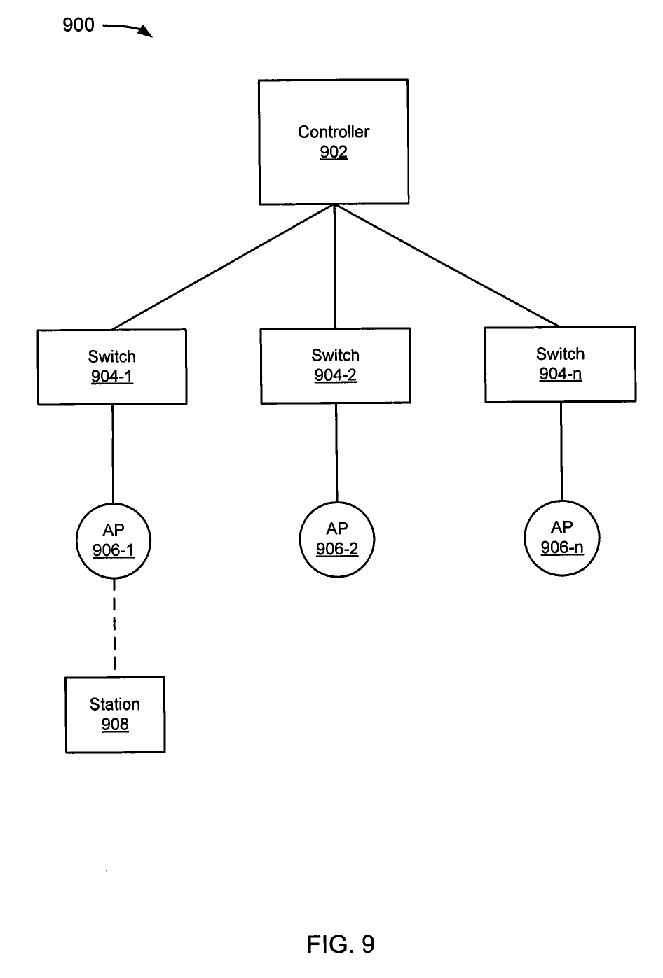

FIG. 9 depicts an example of a system 900 performing a link layer performance test. FIG. 9 includes controller 902, switch 904-1, switch 904-2, switch 904-n (collectively switches 904), AP 906-1, AP 906-2, AP 906-n (collectively APs 906), and station 908.

In the example of FIG. 9 controller 902 is coupled to switches 904. The controller 902 oversees the network and monitors connections of stations to APs. One or more of the switches 904 and the controller 902 may be the same unit. Alternatively, the switches 904 may be separate units from the controller 902 and receive instructions from the controller 902 via a network. The network may be practically any type of communication network, such as, but not limited to, the Internet or an infrastructure network.

In the example of FIG. 9 the APs 906 are hardware units that act as a communication node by linking wireless stations, such as PCs, to a wired backbone network. The APs 906 may generally broadcast a service set identifier (SSID). The APs 906 may serve as a point of connection between a wireless local area network (WLAN) and a wired network. The APs may have one or more radios. The radios can be configured for 802.11 standard transmissions.

In the example of FIG. 9 the station 908 may be any computing device capable of WLAN communication. Station 908 may be, but is not limited to, an AP, a mesh point, a mesh station, a mesh AP, or a client station. Station 908 is coupled wirelessly to AP 906-1.

In the example of FIG. 9, in operation, the controller 902 triggers a test of the path between AP 906-1 and station 908. The test may be triggered in response to a predetermined event such as, but not limited to, a user complaint or a specified monitoring period. The trigger is sent to the AP 906-1, through switch 904-1, and the AP 906-1 initiates a test. Testing may include sending a test packet from the AP 906-1 to the station 908, and in a bi-directional test also sending a test packet from the station 908 to the AP 906-1. The controller 902 can measure the performance of the test packet. The AP 906-1 can include a layer 2 performance engine (not shown) to measure the performance of the path.

Feedback enabling parameter values can be calculated based on the performance of the path in reference to the test packet. The values may be calculated for, but is not limited to, one or more of: a prioritization parameter, a security parameter, an aggregation parameter, and a data rate parameter. The feedback enabling parameter values can be stored for later access or may be transmitted to the controller where they can be forwarded to a systems administrator.

Consider a real world problem, for example, that station 908 is in use by an individual having a performance problem that is caused by an unknown issue with the user's station 908 and not with the AP 906-1, the switch 904-1 or the controller 902. The controller 902 is managed by a network administrator located in a different building from the user of the station 908. After receiving a complaint from the user of the station 908, the system administrator triggers a test of the performance of the station 908. Having determined that all network communication between the station 908 and the controller 902, the network administrator is able to rule out problems with the network infrastructure providing communication to the station 908. Advantageously, the network administrator is able to save valuable time by avoiding substantial testing of individual parts of the network. The network administrator then performs maintenance directly on the station 908 and restores performance for the user of the station 908.

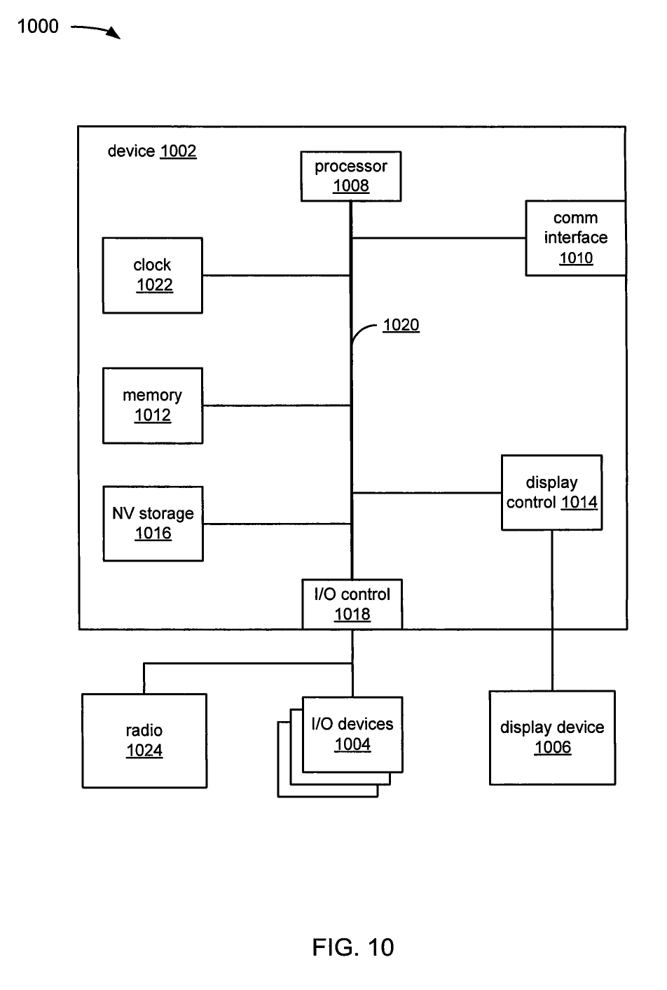

FIG. 10 depicts an example of a system 1000 for performing a link layer performance test. The system 1000 may be a conventional computer system that can be used as a client computer system, such as a wireless client or a workstation, or a server computer system. The system 1000 includes a device 1002, I/O devices 1004, and a display device 1006. The device 1002 includes a processor 1008, a communications interface 1010, memory 1012, display controller 1014, non-volatile storage 1016, I/O controller 1018, clock 1022, and radio 1024. The device 1002 may be coupled to or include the I/O devices 1004 and the display device 1006.

The device 1002 interfaces to external systems through the communications interface 1010, which may include a modem or network interface. It will be appreciated that the communications interface 1010 can be considered to be part of the system 1000 or a part of the device 1002. The communications interface 1010 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 1008 may be, for example, a conventional microprocessor such as an Intel Pentium microprocessor or Motorola power PC microprocessor. The memory 1012 is coupled to the processor 1008 by a bus 1020. The memory 1012 can be Dynamic Random Access Memory (DRAM) and can also include Static RAM (SRAM). The bus 1020 couples the processor 1008 to the memory 1012, also to the non-volatile storage 1016, to the display controller 1014, and to the I/O controller 1018.

The I/O devices 1004 can include a keyboard, disk drives, printers, a scanner, and other input and output devices, including a mouse or other pointing device. The display controller 1014 may control in the conventional manner a display on the display device 1006, which can be, for example, a cathode ray tube (CRT) or liquid crystal display (LCD). The display controller 1014 and the I/O controller 1018 can be implemented with conventional well known technology.

The non-volatile storage 1016 is often a magnetic hard disk, flash memory, an optical disk, or another form of storage for large amounts of data. Some of this data is often written, by a direct memory access process, into memory 1012 during execution of software in the device 1002. One of skill in the art will immediately recognize that the terms “machine-readable medium” or “computer-readable medium” includes any type of storage device that is accessible by the processor 1008.

Clock 1022 can be any kind of oscillating circuit creating an electrical signal with a precise frequency. In a non-limiting example, clock 1022 could be a crystal oscillator using the mechanical resonance of vibrating crystal to generate the electrical signal.

The radio 1024 can include any combination of electronic components, for example, transistors, resistors and capacitors. The radio is operable to transmit and/or receive signals.

The system 1000 is one example of many possible computer systems which have different architectures. For example, personal computers based on an Intel microprocessor often have multiple buses, one of which can be an I/O bus for the peripherals and one that directly connects the processor 1008 and the memory 1012 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1012 for execution by the processor 1008. A Web TV system, which is known in the art, is also considered to be a computer system, but it may lack some of the features shown in FIG. 10, such as certain input or output devices. A typical computer system will usually include at least a processor, memory, and a bus coupling the memory to the processor.

In addition, the system 1000 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1016 and causes the processor 1008 to execute the various acts required by the operating system to input and output data and to store data in memory, including storing files on the non-volatile storage 1016.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A method comprising:
triggering a test of a path between a first station and a second station;
identifying one or more feedback enabling parameters associated with the path;
transmitting a test packet from the first station to the second station;
measuring, in response to the test packet, performance of the path between the first station and the second station;
generating one or more feedback enabling parameter values from the measured performance of the path, wherein the feedback enabling parameter values facilitate changing characteristics of the path.

2. The method of claim 1 further comprising performing an action to improve performance of the path.

3. The method of claim 1 further comprising performing an action to decrease performance of the path to slow down communications on the path.

4. The method of claim 1 wherein the one or more feedback enabling parameters are selected from: a prioritization parameter, an aggregation parameter, a security parameter, and a data rate parameter.

5. A system comprising
a first station;
a layer 2 performance engine (L2PE);
a second station;
wherein, in operation,
the first station transmits a test packet to the second station to initiate measurement of the performance of a path between the first station and the second station,
the L2PE measures performance of the path between the first station and the second station,
the L2PE generates feedback enabling parameter values from the measured performance of the path,
the L2PE records the feedback enabling parameter values.

6. The system of claim 5 further comprising one or more intermediary mesh points; wherein the path includes the one or more intermediary mesh points.

7. The system of claim 5 further comprising a layer 2 performance test controller configured to initiate the test and receive the feedback enabling parameters.

8. The system of claim 5 further comprising a layer 3 performance engine.

9. The system of claim 5 wherein the first station includes an access point (AP).

10. The system of claim 5 wherein the first station includes a mesh point.

11. The system of claim 5 wherein the first station includes a mesh point portal or mesh AP.

12. The system of claim 5 wherein the second station includes a client station.

13. The system of claim 5 wherein the second station includes a mesh station.

14. The system of claim 5 wherein the second station includes a mesh point.

15. The system of claim 5 wherein the second station includes a mesh AP.

16. A method comprising:
triggering a test of a multi-hop path between a mesh point and a station, wherein the path includes one or more intermediary mesh points;
identifying one or more feedback enabling parameters associated with the multi-hop path;
measuring performance of the multi-hop path between the mesh point and the station;
generating values of the feedback enabling parameters in accordance with the measured performance;
recording the feedback enabling parameter values.

17. The method of claim 1 further comprising routing network traffic based on the measured performance of the path.

18. A system comprising:
a first mesh point;
a second mesh point;
a mesh path performance engine (MPPE);
one or more intermediary mesh points;
wherein, in operation,
the MPPE receives a command to trigger a test of a multi-hop path between the first mesh point and the second mesh point;
the MPPE identifies one or more feedback enabling parameters associated with the multi-hop path;
the first mesh point transmits a test packet to the second mesh point via the multi-hop path;
the MPPE measures performance of the multi-hop path between the first mesh point and the second mesh point through the one or more intermediary mesh points;
the MPPE generates feedback enabling parameter values from the measured performance of the multi-hop path;
the MPPE records the feedback enabling parameter values.

19. The system of claim 18 wherein, the MPPE measures performance of a second path between the first mesh point and the second mesh point through a second one or more intermediary mesh points.

20. The system of claim 18 further comprising a high level engine (HLE) wherein the HLE instructs the MPPE to test the multi-hop path.
